(19) United States
(12) Patent Application Publication
(10) Pub. No.: US 2026/0075150 A1
(43) Pub. Date: Mar. 12, 2026

(54) INFORMATION PROCESSING DEVICE, CONTROL METHOD FOR INFORMATION PROCESSING DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Toshiya KONDO, Shiojiri-shi (JP)

(21) Appl. No.: 19/322,793

(22) Filed: Sep. 9, 2025

(30) Foreign Application Priority Data
Sep. 10, 2024 (JP) 2024-156635

(51) Int. Cl. H04N 1/00; B32B 27/10

(52) U.S. Cl. CPC H04N 1/00676; B32B 27/10

(57) ABSTRACT

An information processing device is provided, the device including: an image acceptance unit configured to accept a plurality of images to be print targets; a post-processing information acquisition unit configured to acquire post-processing information for each of the plurality of images, the post-processing information being information corresponding to the images and being information about post-processing to be executed after execution of printing; and an arrangement processing unit configured to execute arrangement processing, which is processing of setting an arrangement of the plurality of images on a medium, based on the post-processing information, wherein when a number of adjacent images having different post-processing information, of the plurality of images, is defined as a number of adjacent different types, the arrangement processing unit executes the arrangement processing such that the number of adjacent different types after the arrangement processing is smaller than the number of adjacent different types before the arrangement processing.

The present application is based on, and claims priority from JP Application Serial Number 2024-156635, filed Sep. 10, 2024, the disclosure of which is hereby incorporated by reference herein in its entirety.

### BACKGROUND

### 1. Technical Field

The present disclosure relates to an information processing device, a control method for an information processing device, and a non-transitory computer-readable storage medium storing a program.

### 2. Related Art

According to the related art, nested printing in which images are printed as arranged side by side in a main scanning direction intersecting a paper conveyance direction (for example, JP-A-2024-014317) is known. JP-A-2024-014317 discloses a technique for preventing a margin from being generated around an image even when the sizes of individual images included in a plurality of images are different between the images (see paragraph 0006).

Meanwhile, a cutting device that cuts out a desired image after the execution of printing is known (for example, JP-A-2005-297248). JP-A-2005-297248 discloses that a cutter 88 is held by a pen grip 78 of a cutter holder 74, and a cutter blade 88a is attached in a replaceable manner at the tip of the cutter 88 (see paragraph 0038 and FIG. 4).

JP-A-2024-014317 and JP-A-2005-297248 are examples of the related art.

However, when nested printing as in JP-A-2024 014317 is performed without considering the type of post-processing to be executed after the execution of printing, a post-processing tool such as a cutter blade needs to be replaced according to the type of post-processing and therefore the post-processing needs to be interrupted every time replacement is performed, and this results in poor efficiency of the post-processing.

### SUMMARY

An object of the present disclosure is to provide an information processing device, a control method for an information processing device, and a non-transitory computer-readable storage medium storing a program that can improve the efficiency of the post-processing executed after the execution of printing.

According to an aspect of the present disclosure, an information processing device includes: an image acceptance unit configured to accept a plurality of images to be print targets; a post-processing information acquisition unit configured to acquire post-processing information for each of the plurality of images, the post-processing information being information corresponding to the images and being information about post-processing to be executed after execution of printing; and an arrangement processing unit configured to execute arrangement processing, which is processing of setting an arrangement of the plurality of images on a medium, based on the post-processing information, wherein when a number of adjacent images having different post-processing information, of the plurality of images, is defined as a number of adjacent different types, the arrangement processing unit executes the arrangement processing such that the number of adjacent different types after the arrangement processing is smaller than the number of adjacent different types before the arrangement processing.

According to another aspect of the present disclosure, an information processing device includes: an image acceptance unit configured to accept a plurality of images to be print targets; a post-processing information acquisition unit configured to acquire post-processing information for each of the plurality of images, the post-processing information being information corresponding to the images and being information about post-processing to be executed after execution of printing; and an arrangement processing unit configured to execute arrangement processing, which is processing of setting an arrangement of the plurality of images on a medium, based on the post-processing information, wherein when a number of adjacent images having different post-processing information, of the plurality of images, is defined as a number of adjacent different types, the arrangement processing unit executes the arrangement processing such that the number of adjacent different types is minimized.

According to still another aspect of the present disclosure, a control method for an information processing device includes: causing an image acceptance unit to accept a plurality of images to be print targets; causing a post-processing information acquisition unit to acquire post-processing information for each of the plurality of images, the post-processing information being information corresponding to the images and being information about post-processing to be executed after execution of printing; and causing an arrangement processing unit to execute arrangement processing, which is processing of setting an arrangement of the plurality of images on a medium, based on the post-processing information, wherein when a number of adjacent images having different post-processing information, of the plurality of images, is defined as a number of adjacent different types, the arrangement processing unit executes the arrangement processing such that the number of adjacent different types after the arrangement processing is smaller than the number of adjacent different types before the arrangement processing.

According to still another aspect of the present disclosure, a non-transitory computer-readable storage medium storing a program is provided, the program causing a computer to function as: an image acceptance function of accepting a plurality of images to be print targets; a post-processing information acquisition function of acquiring post-processing information for each of the plurality of images, the post-processing information being information corresponding to the images and being information about post-processing to be executed after execution of printing; and an arrangement processing function of executing arrangement processing, which is processing of setting an arrangement of the plurality of images on a medium, based on the post-processing information, wherein when a number of adjacent images having different post-processing information, of the plurality of images, is defined as a number of adjacent different types, the arrangement processing function includes a function of executing the arrangement processing such that the number of adjacent different types after the arrangement processing is smaller than the number of adjacent different types before the arrangement processing.

### BRIEF DESCRIPTION OF THE DRAWINGS

FIG. 1 is a block diagram showing an overall configuration.

FIG. 2 is a block diagram showing the configuration of a cutting machine.

FIG. 3 shows an example of a printed object.

FIG. 4 is a block diagram showing the configuration of a printing device.

FIG. 5 shows an example of cutting machine information.

FIG. 6 shows an example of attribute values added to images.

FIG. 7 shows an example of a screen of an application.

FIG. 8 shows an example of a screen of an application.

FIG. 9 shows an example of a screen of an application.

FIG. 10 shows an example of a screen of an application.

FIG. 11 is a flowchart showing control processing of an information processing device.

FIGS. 12A and 12B show an example of arrangement of images.

FIGS. 13A and 13B show an example of arrangement of images.

FIGS. 14A and 14B show an example of arrangement of images.

FIGS. 15A and 15B show an example of arrangement of images.

FIG. 16 shows an example of cutting machine information.

### DESCRIPTION OF EMBODIMENTS

Embodiments of the present disclosure will now be described in the following order.
(1) Overall Configuration
(2) Detailed Configuration of Cutting Machine
(3) Detailed Configuration of Cutting Terminal
(4) Detailed Configuration of Printing Device
(5) Detailed Configuration of Printing Terminal
(6) Control Processing of Information Processing Device
(7) Other Embodiments

### (1) OVERALL CONFIGURATION

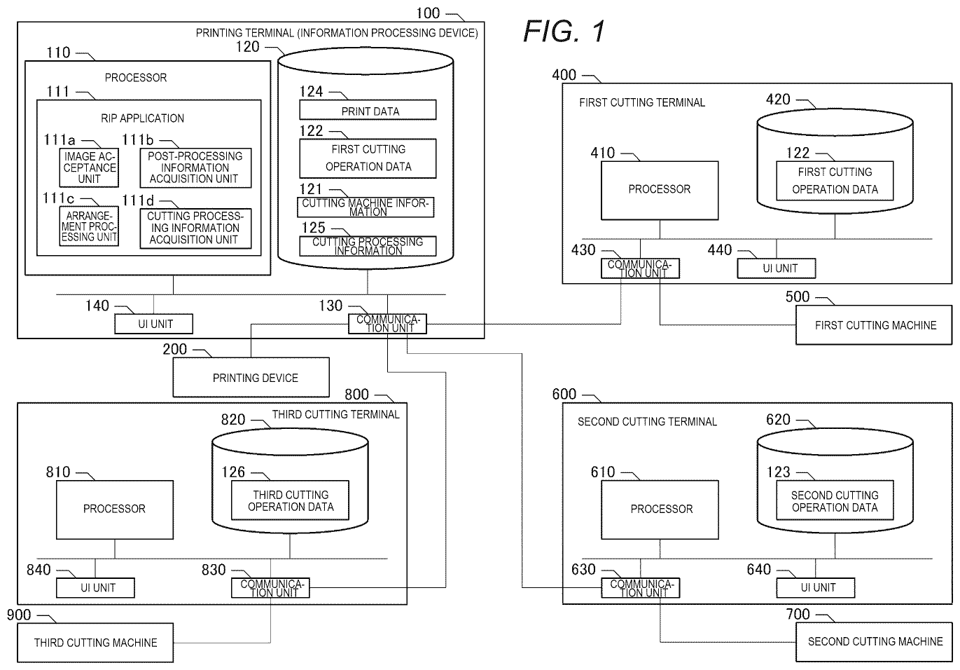

FIG. 1 shows the configuration of an entire system including a printing terminal 100 as an information processing device according to an embodiment of the present disclosure. The printing terminal 100 executes a raster image processor (RIP) application 111, and thus accepts a print target image, generates print data for a printing device 200 to print an image whose arrangement on a medium is set according to a print condition and a cutting condition, and causes the printing device 200 to print the print data. By executing the RIP application 111, the printing terminal 100 generates cutting operation data representing a cutting operation command from the print target image and transmits the cutting operation data to the cutting terminal.

The printing device 200 in the present embodiment prints an image on a sheet-shaped (roll paper) medium. A cutting machine cuts the medium on which the image is printed, based on the cutting operation data generated according to the shape of the image.

In FIG. 1, three types of cutting machines, that is, a first cutting machine 500, a second cutting machine 700, and a third cutting machine 900 are provided, but the number of cutting machines is not limited thereto.

### (2) DETAILED CONFIGURATION OF CUTTING MACHINE

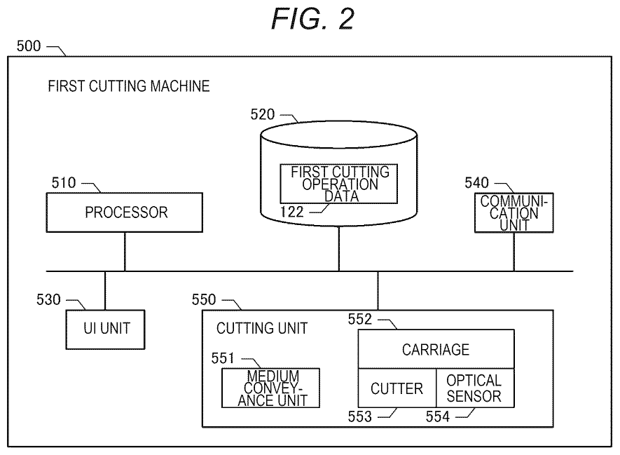

FIG. 2 is a block diagram showing the configuration of the first cutting machine 500. Since the second cutting machine 700 and the third cutting machine 900 have a similar configuration, the description of the individual cutting machines will be omitted. Note that the configuration and specifications of a cutting unit 550 may differ among the cutting machines. The cutting machine is also referred to as a cutting plotter.

The first cutting machine 500 includes a processor 510, a nonvolatile memory 520, a UI unit 530, a communication unit 540, and the cutting unit 550. The processor 510 includes a CPU, a ROM, a RAM, and the like, not shown, and executes a cutting control program recorded in the nonvolatile memory 520 and thus controls each part of the first cutting machine 500.

The processor 510 may be configured with a single chip, may be configured with a plurality of chips, or may be configured as an SoC with various functional blocks. Also, for example, the CPU may be replaced with an ASIC, or the CPU and an ASIC may cooperatively operate. Also, when other devices (for example, the printing terminal 100, the printing device 200, a first cutting terminal 400, a second cutting terminal 600, a third cutting terminal 800, the second cutting machine 700, the third cutting machine 900, and the like) in the embodiment include a processor, the processor can be implemented in various forms similarly to the processor 510.

The UI unit 530 includes a touch panel display, switches, an LED, a speaker, and the like. The UI unit 530 presents various information related to the first cutting machine 500 to the user of the first cutting machine 500 and accepts an operation from the user, under the control of the processor 510. The communication unit 540 includes a communication interface for communicating with another device according to various protocols for wired or wireless communication. In the present embodiment, the first cutting machine 500 can communicate with the first cutting terminal 400 via the communication unit 540. Upon receiving first cutting operation data 122 for executing the cutting operation from the first cutting terminal 400, the processor 510 stores the first cutting operation data 122 in the nonvolatile memory 520.

The cutting unit 550 includes a medium conveyance unit 551, a carriage 552, a cutter 553, and an optical sensor 554. In the present embodiment, the medium conveyance unit 551 includes a sensor, an actuator, and a mechanical component for conveying a printed object which is a medium in the form of roll paper and is produced by the printing device 200, based on the first cutting operation data 122. The cutter 553 includes a cutter blade that cuts the medium, and an actuator that drives the cutter blade in a direction orthogonal to the surface of the medium.

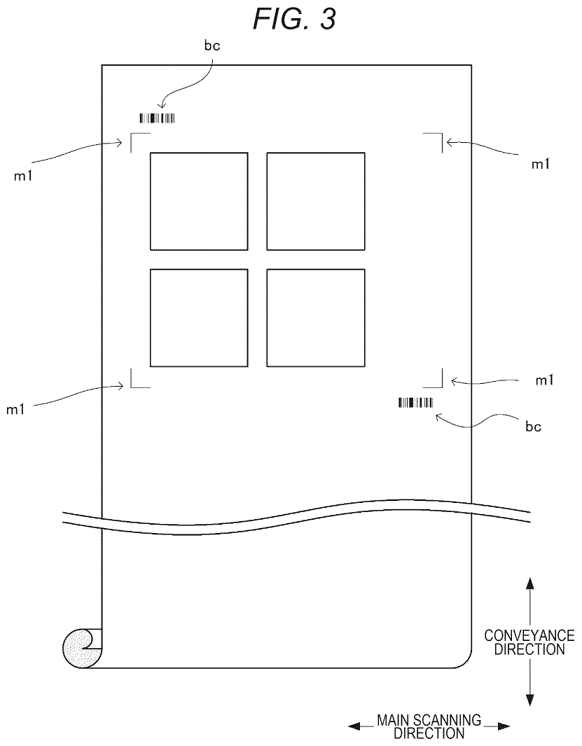

FIG. 3 is a schematic diagram showing an example of a printed object, and shows a conveyance direction, which is a direction in which a medium is conveyed when set in the cutting machine, and a main scanning direction, which is a direction in which the carriage 552 scans. The main scanning direction is a direction orthogonal to the conveyance direction of the medium. The carriage 552 is supported by a rail or the like, not illustrated. The carriage 552 is moved in a direction parallel to a printing surface of the medium by a motor, an actuator, and a mechanical component, not illustrated. In this example, the direction parallel to the printing surface of the medium is, for example, the main scanning direction. The cutter 553 and the optical sensor 554 are installed in the carriage 552. The carriage 552 is provided with a holder, not illustrated. The holder is the attachment position of the cutter blade of the cutter 553, and the cutter blade is detachably held via the holder provided in the carriage 552. The cutter blade held by the holder of the carriage 552 in this manner is driven in a direction orthogonal to the surface of the sheet-shaped medium by an actuator, not illustrated, and the edge of the cutter blade is brought into contact with or moved away from the medium. In a state where the edge of the cutter blade is in contact with the medium, the carriage 552 holding the cutter blade moves in the main scanning direction and the medium is conveyed in the conveyance direction orthogonal to the direction of movement of the carriage 552, and cutting processing of the image formed on the medium is thus performed. The cutting machine may be a flat bed type device in which the medium conveyance unit is omitted, and in this case, the direction of movement of the carriage 552 is not limited to only the width direction (direction corresponding to the main scanning direction) of the medium and includes the longitudinal direction (direction corresponding to the conveyance direction) orthogonal to the width direction of the medium. The configuration of the cutting machine is not particularly limited as long as the cutting machine executes cutting by causing the cutter installed in the carriage to run.

The optical sensor 554 moves while being held by the carriage 552. The optical sensor 554 includes a light emitting unit and a light acceptance unit, emits light to the medium, receives reflected light from the medium, and thus reads a cutting mark ml and a barcode bc printed on the medium. The cutting mark ml is a mark used for the cutting machine to perform position alignment with the medium on which the image to be cut is printed, and the image to be cut is printed in a rectangular area having a reference point of each cutting mark ml as a vertex. The barcode bc includes reference information for referring to the position of the cutting mark ml and the first cutting operation data 122 (vector data group (a set of vectors defining a cutting start position and a cutting end position)) for cutting the image present in the rectangular area indicated by the cutting mark ml, along a cutting line. The reference information may be in any form as long as the processor 510 can acquire desired cutting operation data, and is represented by, for example, a path indicating the storage location of the first cutting operation data 122, the file name of the first cutting operation data 122, or the like.

When instructed to read the barcode via the UI unit 530, the processor 510 causes the medium conveyance unit 551 to convey the medium, moves the carriage 552, and causes the optical sensor 554 to read the barcode. When the read barcode indicates the reference information of the first cutting operation data 122, the processor 510 acquires the first cutting operation data 122 from the first cutting terminal 400, based on the reference information. The processor 510 also reads the cutting mark ml and performs position alignment for the cutting operation (for example, a position on the medium indicated by one of the four cutting marks ml is used as a reference for driving the medium conveyance unit 551 and the carriage 552). The processor 510 acquires the first cutting operation data 122, based on the reference information indicated by the barcode, controls the medium conveyance unit 551, the carriage 552, and the cutter 553, based on the vector data group indicated by the first cutting operation data 122, and performs the cutting operation.

In the above embodiment, an example in which the optical sensor 554 installed in the carriage 552 reads the barcode bc or the cutting mark ml has been described, but the form of reading the barcode bc or the cutting mark ml is not limited thereto. For example, a cutting machine provided with an optical sensor in which the entirety of a set medium falls within in the image capture range thereof may be adopted. The barcode bc may be replaced with a two-dimensional code, a number, a character, a symbol, or the like.

### (3) DETAILED CONFIGURATION OF CUTTING TERMINAL

As shown in FIG. 1, in the present embodiment, one cutting terminal is coupled to each cutting machine. The cutting terminal is configured with a PC or a tablet, and implements a function of receiving cutting operation data from the printing terminal 100 and outputting the cutting operation data to the cutting machine. In FIG. 1, the cutting terminal corresponding to the first cutting machine 500 is referred to as the first cutting terminal 400, the cutting terminal corresponding to the second cutting machine 700 is referred to as the second cutting terminal 600, and the cutting terminal corresponding to the third cutting machine 900 is referred to as the third cutting terminal 800.

In this example, the first cutting terminal 400 will be described as the configuration of the cutting terminal. Since the second cutting terminal 600 and the third cutting terminal 800 have a configuration similar to that of the first cutting terminal 400, the description thereof will be omitted. The first cutting terminal 400 includes a processor 410, a nonvolatile memory 420, a communication unit 430, and a UI unit 440.

The communication unit 430 includes a communication interface that communicates with another device according to various protocols for wired or wireless communication. In the present embodiment, the processor 410 can communicate with the printing terminal 100 and the first cutting machine 500 via the communication unit 430. The communication unit 430 may include an interface for communicating with various removable memories attached to the printing device 200. The UI unit 440 includes a display and a switch, and the processor 410 displays various information on the display and accepts an operation performed on the switch.

When the use of the first cutting machine 500 in the cutting process, which is a post-process of the printing process, is selected in the printing terminal 100, the printing terminal 100 also generates the first cutting operation data 122 for cutting the medium by the first cutting machine 500 when generating print data 124. The first cutting terminal 400 receives the generated first cutting operation data 122 from the printing terminal 100 and stores the first cutting operation data 122 in the nonvolatile memory 420. The printing terminal 100 causes the printing device 200 to perform printing, based on the print data, and thus to produce a printed object. When the user sets the printed object in the first cutting machine 500 and gives an instruction to read a barcode printed on the printed object, the first cutting machine 500 reads the barcode and requests the first cutting operation data 122 from the first cutting terminal 400, based on the reference information indicated by the barcode. The processor 410 of the first cutting terminal 400 transmits the first cutting operation data 122 to the first cutting machine 500 in response to the request. The first cutting machine 500 performs the cutting operation as described above, based on the first cutting operation data 122. When the use of the second cutting machine 700 is selected in the printing terminal 100, the printing terminal 100 generates second cutting operation data 123 for the second cutting machine 700 to cut the medium and transfers the second cutting operation data 123 to the second cutting terminal 600, and the second cutting machine 700 performs the cutting operation, based on the second cutting operation data 123. When the use of the third cutting machine 900 is selected in the printing terminal 100, the printing terminal 100 generates third cutting operation data 126 for the third cutting machine 900 to cut the medium and transfers the third cutting operation data 126 to the third cutting terminal 800, and the third cutting machine 900 performs the cutting operation, based on the third cutting operation data 126.

### (4) DETAILED CONFIGURATION OF PRINTING DEVICE

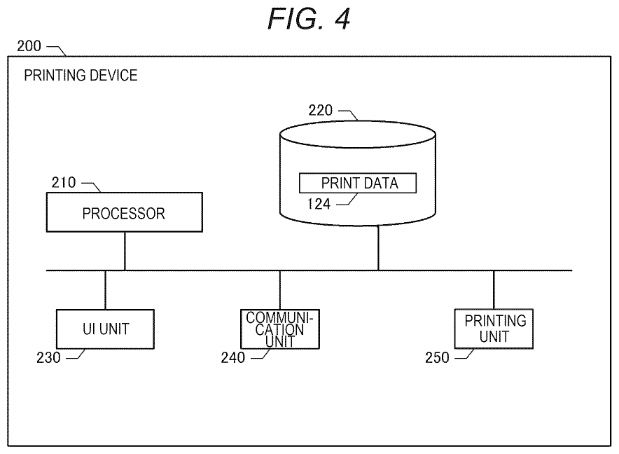

FIG. 4 is a block diagram showing the configuration of the printing device 200 shown in FIG. 1. The printing device 200 includes a processor 210, a nonvolatile memory 220, a UI unit 230, a communication unit 240, and a printing unit 250. The processor 210 executes a control program, not shown, which is recorded in the nonvolatile memory 220, and thus can control each unit of the printing device 200.

The nonvolatile memory 220 stores the print data 124 transmitted from the printing terminal 100, and the processor 210 controls the printing unit 250, based on the print data 124, and thus executes printing.

The UI unit 230 includes a touch panel display, keys, an LED, a speaker, and the like. The processor 210 guides the user to various information via an output unit such as a touch panel display, an LED, or a speaker, and inputs an instruction of the user via an input unit such as a touch panel display or a key.

The communication unit 240 includes a communication interface for communicating with another device according to various protocols for wired or wireless communication. In the present embodiment, the processor 210 can communicate with the printing terminal 100 via the communication unit 240. The communication unit 240 may include an interface for communicating with various removable memories attached to the printing device 200.

In the present embodiment, the printing unit 250 executes printing on a medium in the form of roll paper. The printing unit 250 includes a medium conveyance unit, not illustrated, and a carriage with a print head installed thereon. The print head includes nozzle rows corresponding to, for example, cyan, magenta, yellow, and black inks, and the inks are ejected from the nozzles provided in the nozzle rows. In the present embodiment, a direction in which a medium is conveyed during the printing of a plurality of images is defined as a first direction (conveyance direction), and a direction orthogonal to the first direction is defined as a second direction (main scanning direction). In other words, the first direction is the longitudinal direction of the roll paper, and the second direction is the width direction of the roll paper. The carriage moves forward and backward along a specific direction (main scanning direction). The medium conveyance unit conveys a print target medium. The medium conveyance unit conveys the medium in a direction orthogonal to the main scanning direction. As the ejection of the inks from the nozzles in the process of the forward and backward movement of the print head and the conveyance of the medium by the medium conveyance unit are repeated, printing on the medium is performed.

The user sets the medium in the printing device 200 and operates the printing terminal 100 to instruct the printing device 200 to execute printing. Also, the user removes the medium (printed object) after the execution of printing from the printing device 200, moves the medium, sets the medium in the cutting machine used in the cutting process, which is a post-process of the printing process, and causes the cutting machine to execute the cutting operation on the medium.

### (5) DETAILED CONFIGURATION OF PRINTING TERMINAL

The configuration of the printing terminal 100 will be described with reference to FIG. 1. The printing terminal 100 is a computer (information processing device) such as a PC or a tablet. The printing terminal 100 includes a processor 110, a nonvolatile memory 120 functioning as a storage unit, a communication unit 130, and a UI unit 140. The nonvolatile memory 120 stores the RIP application 111, various other programs, and cutting machine information 121. When the print data 124 or the cutting operation data (122) is generated, the data may be stored in the nonvolatile memory 120.

The RIP application 111 is not limited to the generation of a raster image for the execution of printing by the printing device 200, and is executed by the processor 110 to execute various kinds of processing including arrangement processing, described later. In the description below, the processing implemented by the function of the RIP application 111 is referred to as RIP processing.

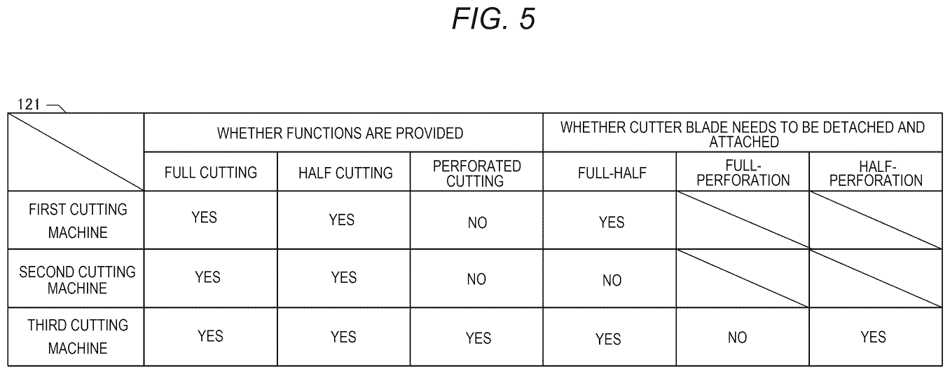

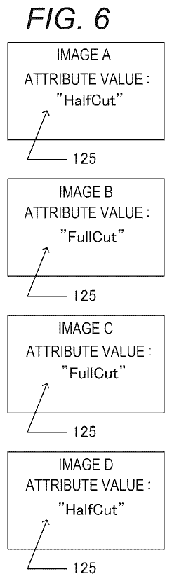

In the present embodiment, the processor 110 executes the RIP application 111 to execute the function of an image acceptance unit 111a, the function of a cutting processing information acquisition unit 111d, the function of a post-processing information acquisition unit 111b, and the function of an arrangement processing unit 111c. The function of the image acceptance unit 111a is a function of accepting a plurality of images to be print targets. The function of the cutting processing information acquisition unit 111d is a function of acquiring, for each of a plurality of images, cutting processing information 125, which is information corresponding to the image and is about whether the cutting processing on the medium is to be executed after the execution of printing and the type of the cutting processing. The function of the post-processing information acquisition unit 111b is a function of acquiring, for each of a plurality of images, post-processing information, which is information corresponding to the image and is information about the post-processing to be executed after the execution of printing. The function of the arrangement processing unit 111c is a function of executing arrangement processing, which is processing of appropriately setting an arrangement of a plurality of images on the medium, based on the post-processing information. In the present embodiment, the post-processing information refers to information indicating the type of post-processing tool (cutter blade) to be used in the post-processing. In the present embodiment, the post-processing information is specified from the content of the post-processing for each image represented by the cutting processing information 125 in FIGS. 1 and 6, the type of function of the post-processing machine (cutting machine) coupled to the post-processing terminal (cutting terminal) indicated by the cutting machine information 121 in FIGS. 1 and 5 (whether the post-processing machine has each function), and information about whether the attachment and detachment of the post-processing tool (cutter blade) is necessary when executing two functions of the functions indicated by the cutting machine information 121 in FIGS. 1 and 5.

The processor 110 executes the RIP application 111 and thus executes the function of a cutting operation data generation unit, not illustrated, that generates cutting operation data for cutting the image and the function of a print data generation unit, not illustrated, that generates print data, based on the print target image, the print condition, and the cutting condition and causes the printing device 200 to execute printing. The function of the cutting operation data generation unit is a function of generating cutting operation data indicating a cutting operation command according to the shape of the image from the print target image.

FIG. 5 is a diagram showing an example of the cutting machine information 121 for specifying the post-processing information. The cutting machine information 121 may be stored in advance in the nonvolatile memory 120, may be acquired from the cutting machine coupled thereto, or may be input by the user. The cutting machine information 121 includes information on whether each cutting machine has functions and whether the cutter blade needs to be replaced. Examples of the functions of each cutting machine include full cutting in which the medium is completely cut in the thickness direction, half cutting in which the medium is cut halfway in the thickness direction, and perforated cutting in which a section where the medium is completely cut in the thickness direction and a section where the medium is not cut at all are alternately arranged. The perforated cutting may also be referred to as perforation. Therefore, whether each cutting machine has functions is information indicating whether the first cutting machine 500, the second cutting machine 700, and the third cutting machine 900 have these functions.

When a plurality of rounds of cutting processing of different types are executed, the same cutter blade may be used, depending on the cutting machine, but the cutter blade may need to be replaced. Also, depending on the cutting machine, a plurality of holders may be provided on the carriage, and a holder to which the cutter blade is to be attached may be designated according to the type of cutting processing. In such cases, the cutter blade attached to one holder needs to be moved to the other holder, or the cutter blade attached to one holder needs to be replaced with another cutter blade and then that cutter blade needs to be attached to the other holder. FIG. 5 shows whether the cutter blade needs to be detached when different types of cutting processing are executed. That is, “full-half” indicates whether the cutter blade needs to be detached when the type of the cutting processing on two adjacent images includes full cutting and half cutting. “Full-perforation” indicates whether the cutter blade needs to be detached when the type of the cutting processing on two adjacent images includes full cutting and perforated cutting. “Half-perforation” indicates whether the cutter blade needs to be detached when the type of the cutting processing on two adjacent images includes half cutting and perforated cutting. That is, whether the cutter blade needs to be detached is information indicating whether it is necessary to replace the cutter blade or move the attachment position. As will be described later, the cutting machine information 121 is used for controlling the arrangement processing.

FIG. 6 is a diagram showing an example of attribute values as the cutting processing information 125 added to images. The image is prepared as image data. The image data is, for example, PDF data, and includes a layer indicating a print target image and a layer indicating a spot color. The spot color name of an object of the layer indicating the spot color describes the type of cutting processing. A cut line is designated as a spot color object. The attribute in the present embodiment means additional information indicating the type of post-processing (cutting processing), and the attribute value means specific data added to the attribute. Specifically, images A and D include information of “Half Cut (half cutting)” as an attribute value, images B and C include information of “Full Cut (full cutting)”, and these attribute values define the types of cutting processing on these images. The attribute value may be stored in a layer name, tag information present in the image, or the like, in addition to the name of a color designated as the spot color of an object in the PDF data.

The UI unit 140 (see FIG. 1) includes a display, a touch panel, a speaker, a microphone, and the like. In the present embodiment, the processor 110 inputs various instructions from the user and outputs various information to the user, via the UI unit 140.

The communication unit 130 includes an interface circuit for communicating with another device. The processor 110 can communicate with the printing device 200, the first cutting terminal 400, the second cutting terminal 600, and the third cutting terminal 800 via the communication unit 130. Peripheral devices such as a keyboard, a mouse, and a display may be coupled to the printing terminal 100 via the communication unit 130, and the processor 110 may be configured to input various information from these peripheral devices or output various information thereto.

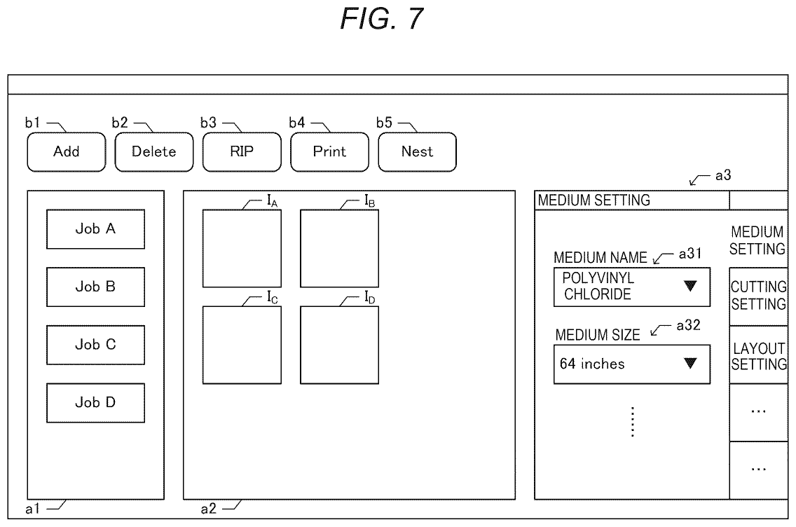

FIG. 7 shows an example of a screen displayed on the display of the UI unit 140 when the processor 110 executes the RIP application 111. As shown in FIG. 7, the screen of the RIP application 111 includes an Add button b1, a Delete button b2, a RIP button b3, a Print button b4, and a Nest button b5. The screen includes an image list section a1, a preview section a2, and a parameter setting section a3.

The Add button b1 is a button for performing an operation of selecting and adding a print target image, and the Delete button b2 is a button for selecting one of print target images and excluding the selected image from the print targets. The image list section a1 is an area for displaying the names of images currently selected as print targets, in a list format.

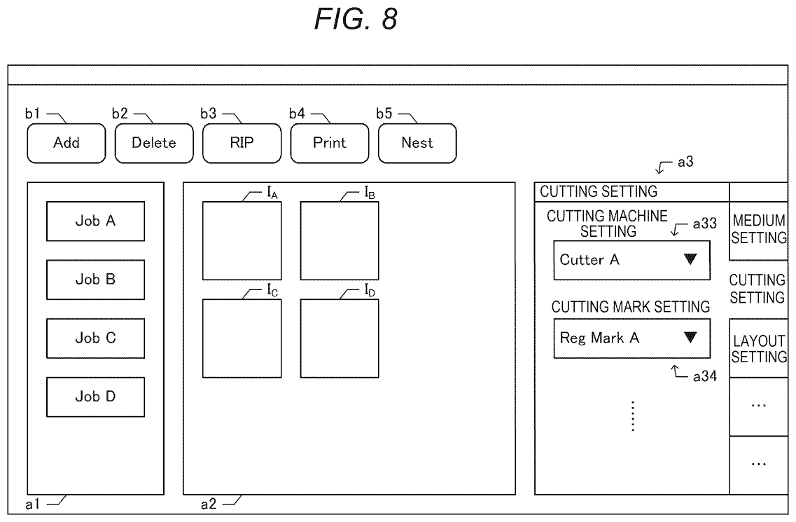

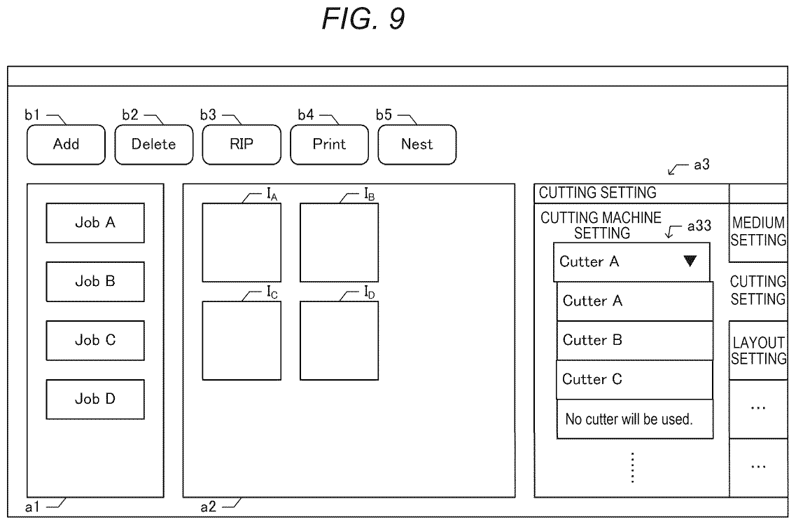

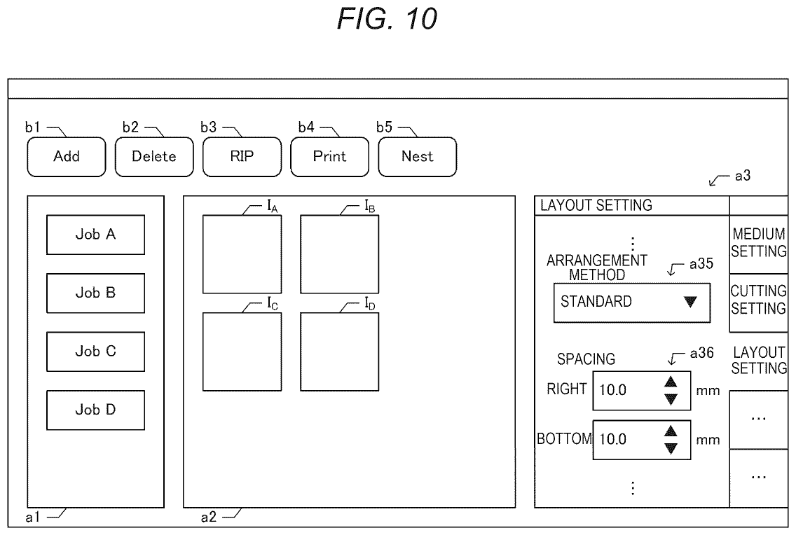

The parameter setting section a3 is a setting section for accepting the designation of various parameters including a medium setting (see FIG. 7), a cutting setting (see FIGS. 8 and 9), and a layout setting (see FIG. 10). The preview section a2 is an area for displaying a preview image of a printed object when an image currently selected as a print target is printed, applying each parameter selected via the parameter setting section a3. The Nest button b5 is a button for giving an instruction to execute processing of automatically arranging a plurality of images side by side.

The RIP button b3 is a button for giving an instruction to perform the RIP processing of the image displayed in the preview section a2 and generating the print data 124. The print data 124 is at least data after the execution of rasterization processing (or may be data after color conversion processing or halftone processing). The Print button b4 is a button for instructing the printing device 200 designated by the user to execute print processing based on the generated print data 124.

With the function of the image acceptance unit 111a, the processor 110 accepts an image as a print target. Specifically, the processor 110 accepts an image designated by the user with the Add button b1 as a print target. The processor 110 accepts a print condition, which is a setting value designated by the user in relation to the printing operation in the parameter setting section a3. Specifically, the processor 110 accepts the print condition via a medium name setting section a31, which is an operation unit for setting the type of the medium, a medium size setting section a32, which is an operation unit for setting the size of the medium, a print quality setting section, not illustrated, which is an operation unit for setting the print quality, and the like.

Also, with the function of a cutting machine designation unit, not illustrated, of the RIP application 111, the processor 110 accepts cutting machine designation information (not illustrated), which is information about the cutting machine for cutting the medium. The cutting machine designation information includes information indicating the type of the cutting machine. The user can select a cutting setting on a setting menu tab, to display the cutting setting shown in FIG. 8. As shown in FIG. 9, a cutting machine setting section a33 is an operation unit that presents a list of cutting machines available for use and allows to select a cutting machine. The list of cutting machines available for use may be configured to display the types of cutting machines manually registered by the user in advance, or may be configured to display the types of the detected cutting machines by automatically detect cutting machines existing in the same network as the printing terminal 100.

FIG. 9 shows an example in which, when three types of cutting machines, that is, Cutter A as a first cutting machine, Cutter B as a second cutting machine, and Cutter C as a third cutting machine, are available, four options of “Cutter A (first cutting machine)”, “Cutter B (second cutting machine)”, “Cutter C (third cutting machine)”, and “No cutter will be used” are displayed as a drop-down menu. “Cutter A (first cutting machine)”, “Cutter B (second cutting machine)”, and “Cutter C (third cutting machine)” indicate options indicating that the cutting machine will be used, and “No cutter will be used” indicates an option indicating that no cutting machine will be used. “No cutter will be used” indicates that cutting processing by a cutting machine will not be performed as the post-process of the printed object. For example, when a large rectangular object for a poster or the like is printed by a printing device, cut by the cutter of the printing device, and completed (or shifted to a post-process other than cutting) without being subjected to a cutting process by a cutting machine, “No cutter will be used” is selected.

When the user selects one of the options from the list in the cutting machine setting section a33, the processor 110 accepts the selection. That is, the processor 110 accepts the option selected by the user as the cutting machine designation information.

Images I_{A}, I_{B}, I_{C}, I_{D} displayed in the preview section a2 in FIGS. 7 to 10 are previews of the respective images (Job A, Job B, Job C, Job D) displayed in the image list section a1. The preview displayed in the preview section a2 of FIG. 7-10 shows the result of automatic imposition processing performed according to the order in which the image acceptance unit accepts the images so that the images do not overlap each other and no extra margin is generated, before the arrangement processing (that is, before the Nest button b5 is pressed). The imposition processing is automatically executed according to a predetermined imposition method (for example, a known imposition method), and the initial arrangement of the plurality of images is determined by the imposition processing. The imposition processing may be manually executed by the user's operation. The preview before the Nest button b5 is pressed does not reflect the setting content in the parameter setting section a3.

By pressing the Nest button b5, the user can give an instruction to automatically execute the arrangement processing (re-imposition processing) of the images as necessary. When the user presses the Nest button b5, the processor 110 accepts the arrangement processing such that the arrangement of the images on the medium is appropriate. The appropriate arrangement of the images means, for example, an arrangement of the images such that the number of times the cutting blade is replaced in the cutting processing by the cutting machine as a post-process is smaller than before the arrangement processing. When the arrangement processing is performed, the processor 110 generates a preview image showing the arrangement of the images after the arrangement processing. Also, acquiring a parameter selected with respect to the layout as shown in FIG. 10 enables appropriately setting of the automatic arrangement of the image in a form desired by the user. For example, an arrangement method setting section a35 and an interval setting section a36 are provided as parameter setting units related to the layout. The arrangement method setting section a35 provides options such as standard (top-left alignment) top-right alignment, bottom-left alignment, and bottom-right alignment. The interval setting section a36 can set an interval from an image adjacent to the right side of the image and an interval from an image adjacent to the bottom side of the image.

When the user presses the Nest button b5 again, the processor 110 returns the arrangement of the images to the state before the above-described automatic arrangement processing. Therefore, in the preview section a2, the images are displayed at the positions before the automatic arrangement processing.

The user can also manually arrange the images. That is, when the user moves an image object in the preview section a2 within the rectangular frame of the preview section a2 by an operation such as drag and drop using a mouse, not illustrated, the processor 110 changes the position of the image to the position after the movement.

A cutting mark setting section a34 illustrated in FIG. 8 is a setting unit for setting the type of a cutting mark for performing position alignment for a cutting target image printed on the medium. The settings menu related to the cutting is not limited thereto, and various other menus may be provided. The cutting mark is a mark indicating a reference position when the cutting machine executes the cutting operation. In the present embodiment, the cutting mark is in the form of two line segments intersecting at a right angle at the end (so-called L-shape). The processor 110 arranges the cutting mark ml outside the area occupied by all the arranged image objects.

Also, the processor 110 arranges, on the medium, a barcode related to the cutting operation to be executed by the cutting machine. That is, the processor 110 generates a barcode indicating the reference information of the cutting operation data, and arranges the barcode bc at a position spaced apart from the cutting mark ml by a predetermined distance outside a rectangular area having the reference point of the cutting mark ml as a vertex.

### (6) CONTROL PROCESSING OF INFORMATION PROCESSING DEVICE

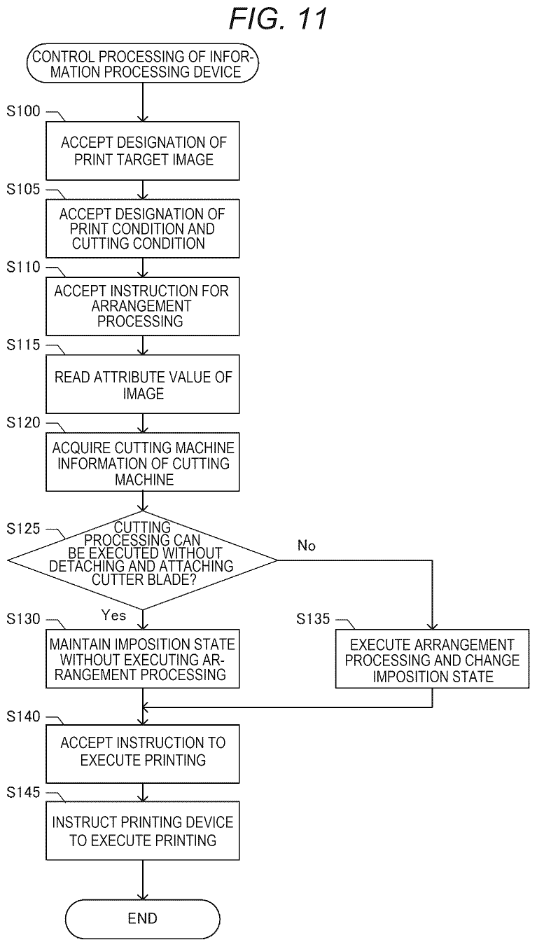

FIG. 11 is a flowchart showing control processing of the information processing device. The processing in FIG. 11 is started when the RIP application is activated in the printing terminal 100. As the control processing is started, the processor 110 accepts a designation of a plurality of print target images (step S100). Specifically, when the user operates the Add button b1 on the screen shown in FIG. 7 to perform an operation of adding a plurality of print target images, the processor 110 acquires the plurality of images that are added, as a print target. The order in which the designations of images are accepted is, for example, the order of the user's operation, that is, the order based on the order in which the user designates images. When the user designates a plurality of images at the same time, the order based on the order of the file names may be the order in which the designations of images are accepted. Immediately after the designations of images are accepted, the above-described imposition processing is executed and the initial arrangement of the plurality of images is determined.

Subsequently, the processor 110 accepts a print condition and a cutting condition of the plurality of print target images that are accepted (step S105). Specifically, when the user selects each setting tab in the parameter setting section a3 and inputs a desired setting (see FIGS. 7, 8, 9, and 10), the processor 110 accepts the input setting value. The setting value set at this time includes the setting value in the cutting machine setting section a33 as shown in FIG. 8. That is, the processor 110 accepts information about whether to execute the cutting using a cutting machine after the printing process, and cutting machine designation information indicating the cutting machine to be used when the cutting machine is to be used.

Subsequently, the processor 110 accepts an instruction for the arrangement processing (re-imposition processing) (step S110). That is, when the user operates the Nest button b5 to give an instruction for the automatic arrangement processing, the processor 110 accepts the instruction for the arrangement processing. The execution of the arrangement processing is not limited to the timing at which the instruction is accepted from the user. As another example, the processor 110 may execute the arrangement processing in response to the acceptance of the designation of the plurality of print target images (step S100) and without accepting an instruction from the user.

Subsequently, the processor 110 reads the attribute value added to each of the plurality of images (step S115). The cutting processing information 125 (attribute value) for specifying post-processing information indicating the content of post-processing is added to each image accepted in step S100. For example, the cutting processing information 125 for specifying the post-processing information includes information about whether cutting processing on the medium is to be performed and the type of the cutting processing. In FIG. 6, an attribute value of “Full Cut (full cutting)” or “Half Cut (half cutting)” is added to the images A to D, and information indicating that the cutting processing is to be performed as the post-processing and information about the type thereof are included. Meanwhile, although not shown, an attribute value of “no cutting processing” is added to an image on which no cutting processing is to be performed, and information indicating that no cutting processing is to be performed as the post-processing is included.

Subsequently, the processor 110 acquires the cutting machine information 121 (see FIG. 5) for specifying the post-processing information of the designated cutting machine (step S120). That is, when the cutting machine designation information indicating that any of the cutting machines is used is accepted in step S105, the processor 110 refers to the cutting machine information 121 shown in FIG. 5, and acquires information about whether the cutting machine designated in step S105 has the functions (whether the cutting machine has the functions of full cutting, half cutting, and perforated cutting) and whether the attachment and detachment of the cutter blade is necessary. For example, when “Cutter A (first cutting machine)” is designated as the cutting machine to be used, the processor 110 determines whether all the types of cutting processing included in the attribute values shown in FIG. 6 are included in the functions of the first cutting machine in FIG. 5. Since the attribute values in FIG. 6 include “Full Cut” and “Half Cut”, the processor 110 determines whether the first cutting machine has all of these functions. When the first cutting machine does not have at least one of these functions, the processor 110 may display a warning to change the setting to another cutting machine. FIG. 5 shows that, when the full cutting and the half cutting included in the attribute values shown in FIG. 6 are executed, the cutter blade needs to be attached and detached in the first cutting machine, and therefore this information is acquired.

Subsequently, the processor 110 determines whether the cutting processing can be executed without attaching and detaching the cutter blade (step S125). That is, since the information about whether the cutter blade needs to be attached and detached is acquired in step S120 as the cutting machine information 121 (see FIG. 5) of the cutting machine designated in step S105, the processor 110 performs the determination based on the information. In the present embodiment, since the cutting machine information 121 indicating that the cutter blade needs to be attached and detached in the first cutting machine is acquired in step S120, the processing proceeds to step S135.

When it is determined in step S125 that the cutting processing can be executed without attaching and detaching the cutter blade (there is no need to attach and detach the cutter blade), the processor 110 maintains the initial imposition state without executing the arrangement processing (step S130). The initial imposition state means, for example, an imposition state automatically executed before the Nest button b5 is pressed as shown in the preview section a2 in FIGS. 7 to 10.

Meanwhile, when it is determined in step S125 that the cutting processing cannot be executed without attaching and detaching the cutter blade (the cutter blade needs to be attached and detached), the processor 110 executes the arrangement processing and thus changes the initial imposition state (step S135). Specifically, with the function of the arrangement processing unit 111c, the processor 110 executes the arrangement processing such that, when the number of adjacent images having different post-processing information, of the plurality of images, is defined as the number of adjacent different types, the number of adjacent different types after the arrangement processing is smaller than the number of adjacent different types before the arrangement processing.

The number of adjacent different types refers to the number of images having different post-processing information and adjacent to each other along the first direction (conveyance direction) and the second direction (main scanning direction), of the plurality of images accepted in step S100. For example, when an image adjacent to a certain image of interest is present above, below, to the left, and to the right, the processor 110 determines whether the post-processing information of the four adjacent images is different from the post-processing information of the image of interest, and when the post-processing information of the four adjacent images is different from the post-processing information of the image of interest, the processor 110 counts these images as the number of adjacent different types. In the present embodiment, that the post-processing information is different means that the types of post-processing tool (cutter blade) for executing the post-processing on the image of interest and the image adjacent to the image of interest are different. If the types of post-processing tool are different, the post-processing tool (cutter blade or the like) needs to be detached and attached when the post-processing is executed on the image of interest and the image adjacent to the image of interest.

The number of adjacent same types refers to the number of images having the same post-processing information and adjacent to each other along the first direction and the second direction, of the plurality of images accepted in step S100. For example, when an image adjacent to a certain image of interest is present above, below, to the left, and to the right, the processor 110 determines whether the post-processing information of the four adjacent images is different from the post-processing information of the image of interest, and when the post-processing information of the four adjacent images is the same as the post-processing information of the image of interest, the processor 110 counts these images as the number of adjacent same types. In the present embodiment, that the post-processing information is the same means that the types of the post-processing tool (cutter blade) for executing the post-processing of the image of interest and the image adjacent to the image of interest are the same. If the types of post-processing tool are the same, the post-processing tool (cutter blade or the like) need not be detached and attached when the post-processing is executed on the image of interest and the image adjacent to the image of interest.

Specifically, the processor 110 specifies the content of the post-processing to be executed on each image, based on the information about the content of the post-processing on each image (see FIG. 6). Then, the processor 110 grasps the type of function of each post-processing machine, based on the information about the type of function of the post-processing machine (cutting machine) coupled to the post-processing terminal (cutting terminal) (whether the post-processing machine has each function) (see FIG. 5). The processor 110 determines whether the content of the post-processing to be executed on each image is executable by the function of the post-processing machine accepted in step S105. When the post-processing is inexecutable, for example, an alert is displayed to the user so as to change to another post-processing machine. In this way, the post-processing machine to be used is specified. Meanwhile, when the post-processing is executable, the processor 110 specifies the type of post-processing in which a common post-processing tool (cutter blade) can be used or cannot be used, based on the information about whether the post-processing tool (cutter blade) needs to be detached and attached when executing two functions of the functions of each post-processing machine (see FIG. 5). Thus, the processor 110 can specify the type of the post-processing tool (cutter blade) to be used in the post-processing, which is the post-processing information, and can determine whether the images adjacent to each other have different post-processing information.

For example, it is assumed that the content of the post-processing to be executed on each image specified by the information about the content of the post-processing on each image (see FIG. 6) includes full cutting, half cutting, and perforated cutting. As shown in FIG. 5, in the specified post-processing machine, full cutting and perforated cutting are defined as the types of post-processing in which a common post-processing tool (cutter blade) can be used, and therefore it is specified that a common cutter blade for full cutting and perforated cutting is to be used when executing these types of post-processing. Meanwhile, in the specified post-processing machine, full cutting and half cutting, and half cutting and perforated cutting, are defined as the types of post-processing in which a common post-processing tool (cutter blade) cannot be used, and therefore it is specified that a cutter blade for half cutting that is a different type from the cutter blade for full cutting and perforated cutting is to be used when executing half cutting. In this way, the processor 110 specifies the type of the post-processing tool (cutter blade) to be used in the post-processing, which is the post-processing information.

The number of adjacent different types before the arrangement processing is the number of adjacent different types for the arrangement of the plurality of images at the timing before an instruction to execute the arrangement processing is accepted from the user (for example, before the Nest button b5 is pressed). The number of adjacent different types before the arrangement processing may be the number of adjacent different types based on the order in which the image acceptance unit accepts the images. The number of adjacent different types after the arrangement processing is the number of adjacent different types for the arrangement of the plurality of images at the timing after an instruction to execute the arrangement processing is accepted from the user and after the arrangement processing is executed.

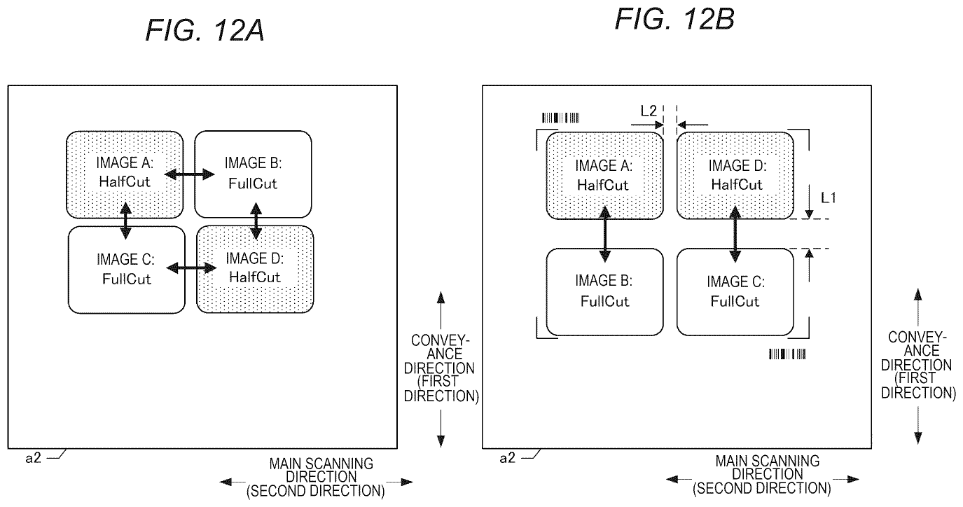

The arrangement processing will now be described in detail with reference to FIGS. 12A and 12B. FIG. 12A illustrates a state where the arrangement (initial imposition state) of a plurality of images at a timing before an instruction to execute the arrangement processing is accepted from the user (for example, before the Nest button b5 is pressed) is displayed in the preview section a2. FIG. 12B illustrates a state where the arrangement (re-imposition state) of the plurality of images at a timing after an instruction to execute the arrangement processing is accepted from the user (for example, after the Nest button b5 is pressed and the arrangement processing is executed) is displayed in the preview section a2.

Since the information of half cutting is added as an attribute value of the images A and D, the cutting processing can be performed on these images with the same cutter blade. Therefore, when these images are adjacent to each other in the conveyance direction or the main scanning direction, the processor 110 counts these images as adjacent same types. Also, since the information of full cutting is added as an attribute value of the images B and C, the cutting processing can be performed on these images with the same cutter blade. Therefore, when these images are adjacent to each other in the conveyance direction or the main scanning direction, the processor 110 counts these images as adjacent same types.

Also, assuming a case where the first cutting device is designated in step S105, the information about whether the cutter blade needs to be detached and attached, included in the acquired cutting machine information 121, indicates the cutter blade needs to be detached and attached (see FIG. 5), and therefore when the image A and the images B and C are adjacent to each other in the conveyance direction or the main scanning direction, and the image D and the images B and C are adjacent to each other in the conveyance direction or the main scanning direction, the processor 110 counts these images as adjacent different types.

That is, the processor 110 counts the number of images having the same post-processing information and adjacent to each other along the first direction (conveyance direction) and the second direction (main scanning direction), of the plurality of images accepted in step S100, as adjacent same types. Meanwhile, the processor 110 counts the number of images having different post-processing information and adjacent to each other along the first direction (conveyance direction) and the second direction (main scanning direction), of the plurality of images accepted in step S100, as adjacent different types. First, when the types of the cutting processing, which are the attribute values (see FIG. 6) as the cutting processing information 125 added to the image, are the same, the processor 110 counts these images as adjacent same types. Meanwhile, even when the types of the cutting processing are different, the processor 110 counts the images as adjacent same types when the information about whether the cutter blade needs to be detached and attached, included in the acquired cutting machine information 121 (see FIG. 5), indicates that the cutter blade need not be detached and attached (that is, when the types of the post-processing tools, which are the post-processing information, are the same), and the processor 110 counts the images as adjacent different types when the information indicates that the cutter blade needs to be detached and attached (that is, when the types of the post-processing tools, which are the post-processing information, are different).

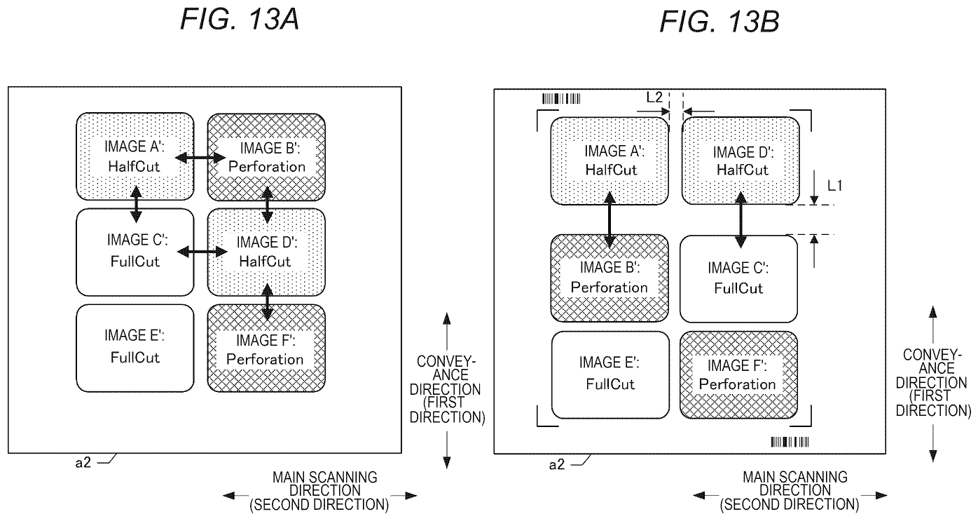

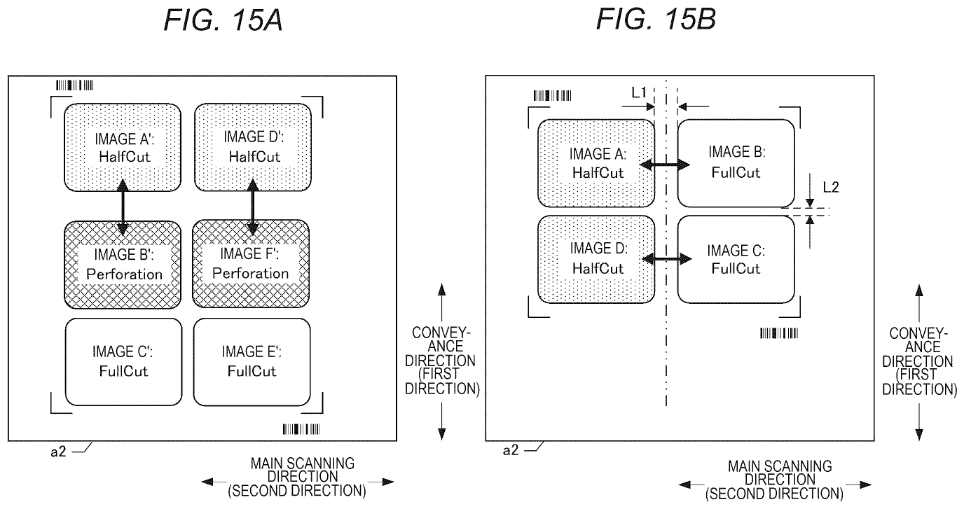

In FIG. 12A, since the images A and D indicating half cutting and the images B and C indicating full cutting are arranged in a lattice-like form, the number of adjacent different types in the conveyance direction and the main scanning direction is 4, and the number of adjacent same types is 0. Meanwhile, in FIG. 12B, the images A and D indicating half cutting are adjacent to each other in the main scanning direction, and the images B and C are adjacent to each other in the main scanning direction below the images A and D. Therefore, these image are adjacent same types in the main scanning direction and adjacent different types in the conveyance direction. Therefore, the number of adjacent different types is 2, and the number of adjacent same types is 2. In FIGS. 12A and 12B, the adjacent different types are indicated by thick arrows, and the adjacent same types are not indicated by arrows (the same applies to FIGS. 13A and 13B and FIGS. 15A and 15B, described later).

Therefore, the arrangement processing according to the present embodiment is processing executed such that the number of adjacent different types after the arrangement processing is smaller than the number of adjacent different types before the arrangement processing. Moreover, the arrangement processing according to the present embodiment is processing of executing the arrangement processing such that the number of adjacent different types after the arrangement processing is smaller than the number of adjacent different types before the arrangement processing, and such that the number of adjacent same types after the arrangement processing is larger than the number of adjacent same types before the arrangement processing. Specifically, the processor 110 sorts out the images into images having the same post-processing information, arranges the images having the same post-processing information at predetermined intervals in the main scanning direction from an end part (for example, the top left corner or the like) of the medium, and arranges the images at predetermined intervals in the conveyance direction and in a form aligned to an end part (for example, the left end part or the like) when there is no space for arranging the images in the main scanning direction. Upon finishing the arrangement of images of one type, the processor 110 performs similar processing on images having different post-processing information at predetermined intervals in the conveyance direction.

In the present embodiment, with the function of the arrangement processing unit 111c, the processor 110 executes the arrangement processing such that the number of adjacent different types in the second direction (main scanning direction) is smaller than the number of adjacent different types in the first direction (conveyance direction). Regardless of the first direction and the second direction, reducing the number of adjacent different types enables a reduction in the frequency of replacing the cutter blade and the frequency of re-attaching the cutter blade to a different attachment position during the cutting processing by the cutting machine. Also, when the arrangement processing is executed such that the number of adjacent different types in the second direction is smaller than the number of adjacent different types in the first direction as described above, jamming of the medium in the cutting machine can be suppressed, as compared with when the arrangement processing is executed such that the number of adjacent different types in the first direction is smaller than the number of adjacent different types in the second direction. When the number of adjacent different types in the first direction is smaller than the number of adjacent different types in the second direction, many images having the same post-processing information are arranged along the first direction and many images having different post-processing information are arranged along the second direction, and the medium which is once conveyed after the images having the same post-processing information along the first direction are cut first and on which the cutting processing is partially executed needs to be returned into the cutting machine and then the cutting processing for the next images needs to be executed, and therefore the medium is likely to be jammed at that time. In contrast, when the number of adjacent different types in the second direction is smaller than the number of adjacent different types in the first direction, many images having the same post-processing information are arranged along the second direction and many images having different post-processing information are arranged along the first direction, and the frequency of returning the medium on which the cutting processing is partially executed into the cutting machine and then executing the cutting processing for the next images can be reduced, and therefore the jamming of the medium in the cutting machine can be suppressed. This can contribute to a reduction in the time required for the cutting processing.

As shown in FIG. 12B, the distance between images having different post-processing information, of the plurality of images, is defined as a distance between different types L1, and the distance between images having the same post-processing information, of the plurality of images, is defined as a distance between same types L2. The processor 110, with the function of the arrangement processing unit 111c, executes the arrangement processing such that the distance between different types L1 is longer than the distance between same types L2, based on the post-processing information. Thus, even when the types of cutting processing are different, a necessary margin (that is, a nip part or the like for the cutting machine to hold the medium) can be secured. Moreover, in the present embodiment, the processor 110, with the function of the arrangement processing unit 111c, executes the arrangement processing such that the distance between different types L1 in the first direction is longer than the distance between same types L2 in the second direction. Thus, the cutting machine stops the cutting processing due to the margin in the first direction and therefore the user can replace the cutter blade at that timing. In this arrangement, the parameter (for example, the interval or the like) accepted in the layout setting shown in FIG. 10 may be reflected in either the distance between different types L1 or the distance between same types L2. Also, making the distance between different types L1 longer than the distance between same types L2 is not essential and may be performed as appropriate according to the post-processing method.

Subsequently, the processor 110 accepts an instruction to execute printing (step S140). That is, when the user operates the Print button b4 after operating the RIP button b3, the processor 110 performs RIP processing on the images shown in the preview section a2 and thus generates the print data 124 and the cutting operation data (122).

Moreover, the processor 110 outputs the print data 124 to the printing device 200 and instructs the printing device 200 to execute printing based on the print data (step S145).

As described above, according to the present embodiment, since the arrangement processing is executed such that the number of adjacent different types after the arrangement processing is smaller than the number of adjacent different types before the arrangement processing, the number of times the post-processing tool (cutter blade) is detached and attached can be reduced even when the type of post-processing is different for each image. Thus, the efficiency of the post-processing executed after the execution of printing can be improved. Also, since the imposition state is changed by automatically performing the imposition processing so as not to generate an extra margin and performing the arrangement processing as necessary, the margin can be reduced to a certain extent while priority is given to reducing the number of times the post-processing tool is detached and attached. For example, the present disclosure includes even a case where a plurality of images are arranged in the conveyance direction (first direction) with a margin generated in the main scanning direction (second direction) of the medium as a result of the arrangement processing.

### (7) OTHER EMBODIMENTS

The foregoing embodiment is an example for carrying out the present disclosure, and various other embodiments can be employed. For example, the information processing device according to the present disclosure may be configured as integrated with the printing device. The information processing device may be configured as a device (server) separate from the terminal operated by the user or the printing device. The information processing device and the cutting terminal may be configured as an integrated device.

Also, in the above embodiment, with reference to FIG. 11, the processing from step S100 to step S145 is sequentially executed, but conditions and the like may be accepted in any order. That is, step S105 and steps S110 to S135 may be performed in any order.

In the above embodiment, with reference to FIGS. 12A and 12B, the comparison of the imposition states before and after the arrangement processing when the first cutting machine is designated and “Full Cut (full cutting)” or “Half Cut (half cutting)” is added to the images A to D as the attribute value indicating whether the cutting processing on the medium is to be performed and the type of the cutting processing, is described. Referring to FIGS. 13A and 13B, the comparison of the imposition states before and after the arrangement processing when the third cutting machine is designated and attribute values of “Full Cut (full cutting)”, “Half Cut (half cutting)”, and “Perforation (perforated cutting)” are added to images A′ to F′ as attribute values indicating whether the cutting processing on the medium is to be performed and the type of the cutting processing, will now be described.

FIG. 13A illustrates a state where the arrangement (initial imposition state) of the plurality of images at a timing before an instruction to execute the arrangement processing is accepted from the user (for example, before the Nest button b5 is pressed) is displayed in the preview section a2. FIG. 13B illustrates a state where the arrangement (re-imposition state) of the plurality of images at a timing after an instruction to execute the arrangement processing is accepted from the user (for example, after the Nest button b5 is pressed and the arrangement processing is executed) is displayed in the preview section a2.

Assuming a case where the third cutting machine is designated in step S105, the information about whether the cutter blade needs to be detached and attached, included in the acquired cutting machine information 121, indicates that the cutter blade needs to be detached and attached between full cutting and half cutting and between half cutting and perforated cutting, and that the cutter blade need not be detached and attached between full cutting and perforated cutting (see FIG. 5). Therefore, when an image to which the attribute value indicating full cutting is added and an image to which the attribute value indicating perforated cutting is added are adjacent to each other in the conveyance direction or the main scanning direction, the processor 110 counts these images as adjacent same types even if the types of the cutting processing thereof are different. Otherwise, when images to which attribute values of different types of cutting processing are added are adjacent to each other in the conveyance direction or the main scanning direction, the processor 110 counts these images as adjacent different types.

In FIG. 13A, since the image C′ and the image E′ to which the attribute value indicating full cutting is added are adjacent to each other in the conveyance direction and have the same type of cutting processing, the processor 110 counts these images as adjacent same types. Meanwhile, the image E′ to which the attribute value indicating full cutting is added and the image F′ to which the attribute value indicating perforated cutting is added are adjacent to each other in the main scanning direction, and the cutting machine information 121 (see FIG. 5) indicates that the cutter blade need not be detached and attached, and therefore the processor 110 counts these images as adjacent same types. Otherwise, the processor 110 counts images as adjacent different types. As a result, the number of adjacent different types is 5, and the number of adjacent same types is 2.

In the present example, too, with the function of the arrangement processing unit 111c, the processor 110 executes the arrangement processing such that the number of adjacent different types after the arrangement processing is smaller than the number of adjacent different types before the arrangement processing, and such that the number of adjacent same types after the arrangement processing is larger than the number of adjacent same types before the arrangement processing. First, since the attribute value of the image A′ indicates half cutting, the image D′ having the same attribute value indicating half cutting is moved to a position adjacent thereto in the main scanning direction. The image A′ and the image D′ are thus adjacent same types. As a result of moving the image D′ to the right of the image A′, the image B′ originally located at that position moves to the left side in the second row. Accordingly, the image C′ moves to the right side in the second row, the image E′ moves to the left side in the third row, and the image F′ sequentially moves to the right side in the third row. Meanwhile, since the cutting machine information 121 (see FIG. 5) indicates that the cutter blade needs to be detached and attached between half cutting and full cutting or perforated cutting, the image A′ and the image B′, and the image D′ and the image C′, are adjacent different types.

Meanwhile, since the cutting machine information 121 indicates that the cutter blade need not be detached and attached between full cutting and perforated cutting, the image B′ and the image C′ or the image E′, and the image F′ and the image C′ or the image E′, are adjacent same types even if the images B′, C′, E′, F′ have different attribute values. As a result, the number of adjacent different types is 2, and the number of adjacent same types is 5. In the present example, too, the processor 110, with the function of the arrangement processing unit 111c, executes the arrangement processing such that the distance between different types L1 in the first direction is longer than the distance between same types L2 in the second direction.

Thus, for example, even when three or more types of post-processing (cutting processing) are provided, the arrangement processing is executed such that the number of adjacent different types after the arrangement processing is smaller than the number of adjacent different types before the arrangement processing, and therefore the number of times the post-processing tool (cutter blade) is detached and attached can be reduced even if the type of post-processing is different for each image. Thus, the efficiency of the post-processing executed after the execution of printing can be improved.

Since the cutter blade need not be detached and attached for the images B′, C′, E′, F′ shown in FIG. 13B, the images having the same attribute value need not be adjacent to each other, but the images showing the same attribute value may be adjacent to each other, as shown in FIG. 15A.

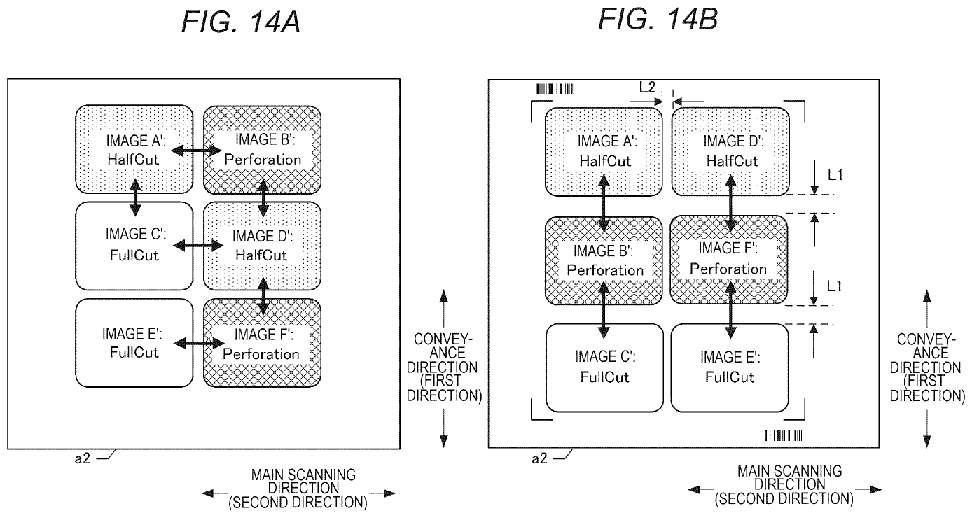

Also, in the above-described embodiment, on the assumption that the post-processing information is the type of the post-processing tool (cutter blade), when the types of the post-processing tools used at the time of the post-processing of the images adjacent to each other are different from each other, the images are counted as adjacent different types, but on the assumption that the post-processing information is the content of the post-processing (whether the cutting processing on the medium is to be performed and the type of the cutting processing), when the contents of the post-processing of the images adjacent to each other are different from each other, the images may be counted as adjacent different types. FIGS. 14A and 14B show an example of the arrangements of images before and after the arrangement processing. The arrangement of the images before the arrangement processing in FIG. 14A is the same as the arrangement in FIG. 13A, but the method of counting the number of adjacent different types is different, the images E′ and F′ are added as adjacent different types, and the number of adjacent different types is 6. Meanwhile, the arrangement of the images after the arrangement processing in FIG. 14B is the same as the arrangement in FIG. 15A, but the method of counting the number of adjacent different types is different, the images B′ and C′ and the images E′ and F′ are added as adjacent different types, and the number of adjacent different types is 4. Even in such a case, the processor 110 executes the arrangement processing such that the number of adjacent different types after the arrangement processing is smaller than the number of adjacent different types before the arrangement processing, and this case is included in the present disclosure.

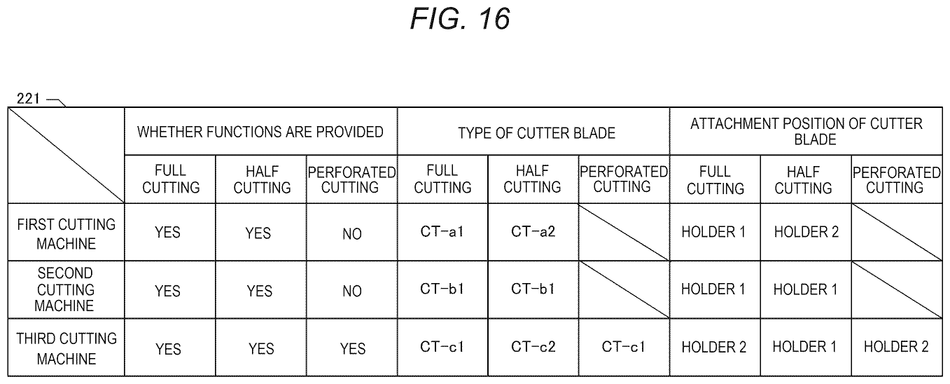

Also, in the above embodiment, the arrangement processing when the standard (top left alignment) is selected in the arrangement method setting section a35 is described with reference to FIGS. 12A to 15B. In this case, in the arrangement processing, when determining the image in the top left corner (the image to be cut first), the image first accepted by the processor 110 with the function of the image acceptance unit is set as the image in the top left corner even after the arrangement processing. However, the processor 110 may determine the image in the top left corner, based on the type of the cutter blade last used in the previous cutting processing and the information about the cutting machine set via the cutting machine setting section a33. That is, the processor 110 may store the type of the cutter blade used last in the previous cutting processing and the information about the cutting machine set via the cutting machine setting section a33, and may refer to cutting machine information 221 shown in FIG. 16 to execute the arrangement processing so as to first execute the cutting processing in which the cutter blade can be used without being detached and attached.

The processor 110 may determine the image in the top left corner, based on the type of the cutter blade currently attached to the holder and the information about the cutting machine set via the cutting machine setting section a33. That is, the processor 110 may recognize the type of the cutter blade currently attached to the holder, store the cutting machine set via the cutting machine setting section a33 in the previous cutting processing, and refer to the cutting machine information 221 shown in FIG. 16 to execute the arrangement processing so as to first execute the cutting processing in which the cutter blade can be used without being detached and attached.

Moreover, the processor 110 may determine the image having the same post-processing information as the image printed last in the previous processing, as the image in the top left corner. That is, the processor 110 may store the attribute value added to the image printed last in the previous processing and the information about the cutting machine set via the cutting machine setting section a33, and refer to the cutting machine information 121 shown in FIG. 5 to execute the arrangement processing so as to first execute the cutting processing in which the cutter blade can be used without being detached and attached. For example, when the attribute value added to the image printed last in the previous processing indicates full cutting and the information about the cutting machine set via the cutting machine setting section a33 in the previous cutting processing indicates the third cutting machine, the image for full cutting or perforated cutting is imposed in the top left corner and therefore the frequency of replacing the cutter blade can be reduced.

Also, in the above embodiment, the arrangement state (initial imposition state) of the images before the execution of the arrangement processing shown in FIG. 12A is changed to the arrangement state of the images shown in FIG. 12B by executing the arrangement processing. That is, in FIGS. 12A and 12B, an example in which the processor 110 executes the arrangement processing such that the number of adjacent different types in the second direction is smaller than the number of adjacent different types in the first direction is described, but it is conceivable that the processor 110 executes the arrangement processing such that the number of adjacent different types in the first direction is smaller than the number of adjacent different types in the second direction. In this case, the arrangement state (initial imposition state) of the images before the execution of the arrangement processing shown in FIG. 12A can be changed to the arrangement state of the images shown in FIG. 15B by executing the arrangement processing. As a result, cutting processing with a slitter that cuts continuous paper along the longitudinal direction is made easier (the two-dot chain line in FIG. 15B indicates a cutting line of the slitter). In this case, the image A and the image B, and the image D and the image C, are adjacent different types, and the image A and the image D, and the image B and the image C, are adjacent same types. The processor 110, with the function of the arrangement processing unit 111c, may execute the arrangement processing such that the distance between different types L1 in the second direction is longer than the distance between same types L2 in the first direction.

In the above embodiment, the cutting machine information 121 and the cutting processing information 125 are information used to specify the post-processing information (the type of post-processing tool) and are not the post-processing information, but the cutting machine information 221 may include information about the type of cutter blade corresponding to the type of the cutting processing as shown in FIG. 16. Also, as shown in FIG. 16, the cutting machine information 221 may include information about the attachment position of the cutter blade corresponding to the type of the cutting processing, in the cutting machine that performs the cutting processing. The processor 110, with the function of the arrangement processing unit 111c, determines whether the cutter blade needs to be replaced, based on at least one of these pieces of information, and executes the arrangement processing, based on the result of the determination.

For example, as the type of the cutter blade, the product number of the cutter blade is registered for each cutting machine and for each type of cutting processing. Even if the type of cutting processing is different, a common cutter blade can be used as long as the product number (type) of the cutter blade is the same. If the type of cutting is different and the product number of the cutter blade is different, a common cutter blade cannot be used.

There are also cutting machines in which the attachment position (holder) of the cutter blade differs, depending on the type of cutting processing. In this case, the attachment position of the cutter blade is registered for each type of cutting machine and cutting processing. Even if the type of cutting processing is different, a common holder can be used if the holder of the cutter blade is the same. Also, if the type of cutting processing is different and the holder of the cutter blade is different, a common holder cannot be used.

In this example, the processor 110, with the function of the arrangement processing unit 111c, determines whether the cutter blade needs to be detached and attached, based on both the information about the type of the cutter blade and the information about the attachment position of the cutter blade. The processor 110, with the function of the arrangement processing unit 111c, determines that the cutter blade needs to be detached and attached, for example, when the type of cutting processing is different and at least one of the product number of the cutter blade and the holder of the cutter blade is different. Meanwhile, the processor 110, with the function of the arrangement processing unit 111c, determines that the cutter blade need not be detached and attached, when the type of cutting processing is different and both the product number of the cutter blade and the holder of the cutter blade are the same. Of course, when the type of cutting processing is the same, it is determined that the cutter blade need not be detached and attached.

Also, the processor 110, with the function of the arrangement processing unit 111c, may determine whether the cutter blade needs to be detached and attached, using one of the information about the type of the cutter blade and the information about the attachment position of the cutter blade. When there is a plurality of pieces of information as described above, the user may select at least one of the pieces of information and the processor 110 may perform the determination, based on the selected information, with the function of the arrangement processing unit 111c.

In this example, since the arrangement processing is executed based on the information about the type of the cutter blade corresponding to the type of cutting processing, the frequency of replacing the cutter blade with a different cutter blade during the cutting processing by the cutting machine can be reduced. Also, in this example, since the arrangement processing is executed based on the information about the attachment position of the cutter blade corresponding to the type of cutting processing in the cutting machine, the frequency of re-attaching the cutter blade at a different attachment position during the cutting processing by the cutting machine can be reduced.

In the above embodiment, only the cutting processing is assumed as the post-processing executed after the execution of printing, but the present disclosure includes various kinds of processing other than the cutting processing as the post-processing. That is, in the above embodiment, the information for specifying the post-processing information is the information about whether the cutting processing on the medium is to be performed and the type of the cutting processing, but may include, for example, information about whether lamination processing and/or foil stamping processing on the medium is to be performed, and the type of the lamination processing and/or the foil stamping processing. The lamination processing means processing of attaching a thin film to the surface of a printed object. The foil stamping processing means processing of attaching a gold foil, a silver foil, or the like to a medium (printed object). Therefore, as the post-processing, the present disclosure can be applied when the post-processing is any of these kinds of processing, and the present disclosure can be applied when the post-processing includes a plurality of kinds of processing. For example, when the post-processing includes cutting processing, lamination processing, and foil stamping processing, there is no combination of same types, and any combination of cutting processing, lamination processing, and foil stamping represents different types.

In the above embodiment, the present disclosure holds when the processor 110, with the function of the arrangement processing unit 111c, executes the arrangement processing such that the number of adjacent different types after the arrangement processing is smaller by at least one than the number of adjacent different types before the arrangement processing, but the processor 110 may be configured to execute the arrangement processing such that the number of adjacent different types is minimized, with the function of the arrangement processing unit 111c according to the present disclosure. That is, the processor 110 may be configured to select an arrangement such that the number of adjacent different types is minimum among the numbers of adjacent different types in arrangements that can be used, with the function of the arrangement processing unit 111c according to the present disclosure. Thus, the number of times the post-processing tool is detached and attached can be reduced, and therefore the efficiency of the post-processing executed after the execution of printing can be improved. Also, the processor 110 may be configured to execute, with the function of the arrangement processing unit 111c, the arrangement processing such that the number of adjacent different types is minimized and the number of adjacent same types is maximized. Moreover, the processor 110 may be configured to execute, with the function of the arrangement processing unit 111c, the arrangement processing in which the margin is minimized in the arrangement in which the number of adjacent different types is minimized. Thus, the margin can be minimized while the efficiency of post-processing executed after the execution of printing is improved.

Moreover, the present disclosure is also applicable as a control method for a computer as an information processing device. For example, the above-described contents can be applied as the disclosure of a control method including: causing an image acceptance unit to accept a plurality of images to be print targets; causing a post-processing information acquisition unit to acquire post-processing information for each of the plurality of images, the post-processing information being information corresponding to the images and being information about post-processing to be executed after execution of printing; and causing an arrangement processing unit to execute arrangement processing, which is processing of setting an arrangement of the plurality of images on a medium, based on the post-processing information, wherein when a number of adjacent images having different post-processing information, of the plurality of images, is defined as a number of adjacent different types, the arrangement processing unit executes the arrangement processing such that the number of adjacent different types after the arrangement processing is smaller than the number of adjacent different types before the arrangement processing. This method can be implemented by causing a processor of a computer as an information processing device to function as the image acceptance unit, the post-processing information acquisition unit, and the arrangement processing unit or the like.

The present disclosure is also applicable as a program executed by a computer as an information processing device. For example, the above-described contents can be applied as the disclosure of a program causing a computer to function as: an image acceptance function of accepting a plurality of images to be print targets; a post-processing information acquisition function of acquiring post-processing information for each of the plurality of images, the post-processing information being information corresponding to the images and being information about post-processing to be executed after execution of printing; and an arrangement processing function of executing arrangement processing, which is processing of setting an arrangement of the plurality of images on a medium, based on the post-processing information, wherein when a number of adjacent images having different post-processing information, of the plurality of images, is defined as a number of adjacent different types, the arrangement processing function includes a function of executing the arrangement processing such that the number of adjacent different types after the arrangement processing is smaller than the number of adjacent different types before the arrangement processing.

The system, the program, and the method as described above may be implemented as a single device or may be implemented by using components provided in a plurality of devices, and may include various forms. Also, the present disclosure may be changed as appropriate, such as a part being software and a part being hardware. Moreover, the present disclosure can be applied as a recording medium storing a program that controls the system. Of course, the recording medium storing the program may be a magnetic recording medium or may be a semiconductor memory, and any recording medium to be developed in the future can be similarly employed.

What is claimed is:

1. An information processing device comprising:
an image acceptance unit configured to accept a plurality of images to be print targets;
a post-processing information acquisition unit configured to acquire post-processing information for each of the plurality of images, the post-processing information being information corresponding to the images and being information about post-processing to be executed after execution of printing; and
an arrangement processing unit configured to execute arrangement processing, which is processing of setting an arrangement of the plurality of images on a medium, based on the post-processing information, wherein
when a number of adjacent images having different post-processing information, of the plurality of images, is defined as a number of adjacent different types,
the arrangement processing unit executes the arrangement processing such that the number of adjacent different types after the arrangement processing is smaller than the number of adjacent different types before the arrangement processing.

2. The information processing device according to claim 1, wherein
the number of adjacent different types before the arrangement processing is the number of adjacent different types for the arrangement of the plurality of images at a timing before an instruction to execute the arrangement processing is accepted from a user.

3. The information processing device according to claim 1, wherein
the number of adjacent different types before the arrangement processing is the number of adjacent different types based on an order in which the image acceptance unit accepts the images.

4. The information processing device according to claim 1, wherein
when a direction in which the medium is conveyed during printing of the plurality of images is defined as a first direction and a direction orthogonal to the first direction is defined as a second direction,
the arrangement processing unit executes the arrangement processing such that the number of adjacent different types in the second direction is smaller than the number of adjacent different types in the first direction.

5. The information processing device according to claim 1, wherein
when a direction in which the medium is conveyed during printing of the plurality of images is defined as a first direction and a direction orthogonal to the first direction is defined as a second direction,
the arrangement processing unit executes the arrangement processing such that the number of adjacent different types in the first direction is smaller than the number of adjacent different types in the second direction.

6. The information processing device according to claim 1, wherein
when a distance between images having different post-processing information, of the plurality of images, is defined as a distance between different types, and a distance between images having the same post-processing information, of the plurality of images, is defined as a distance between same types,
the arrangement processing unit executes the arrangement processing based on the post-processing information such that the distance between different types is longer than the distance between same types.

7. The information processing device according to claim 6, wherein
when a direction in which the medium is conveyed during printing of the plurality of images is defined as a first direction and a direction orthogonal to the first direction is defined as a second direction,
the arrangement processing unit executes the arrangement processing such that the distance between different types in the first direction is longer than the distance between same types in the second direction.

8. The information processing device according to claim 1, wherein
the post-processing information includes information about whether lamination processing on the medium is to be performed and a type of the lamination processing.

9. The information processing device according to claim 1, wherein
the post-processing information includes information about whether foil stamping processing on the medium is to be performed and a type of the foil stamping processing.

10. The information processing device according to claim 1, wherein
the post-processing information includes information about whether cutting processing on the medium is to be performed and a type of the cutting processing.

11. The information processing device according to claim 1, further comprising:
a cutting processing information acquisition unit configured to acquire, for each of a plurality of images, cutting processing information, which is information corresponding to the images and which is about whether cutting processing on the medium is to be performed after execution of printing and a type of the cutting processing, wherein
the post-processing information includes information about a type of a cutter blade corresponding to the type of the cutting processing, and
the arrangement processing unit executes the arrangement processing, based on the information about the type of the cutter blade.

12. The information processing device according to claim 1, further comprising:
a cutting processing information acquisition unit configured to acquire, for each of a plurality of images, cutting processing information, which is information corresponding to the images and which is about whether cutting processing on the medium is to be performed after execution of printing and a type of the cutting processing, wherein
the post-processing information includes information about an attachment position of a cutter blade corresponding to the type of the cutting processing in a cutting processing machine that performs the cutting processing, and
the arrangement processing unit executes the arrangement processing, based on the information about the attachment position of the cutter blade.

13. An information processing device comprising:
an image acceptance unit configured to accept a plurality of images to be print targets;
a post-processing information acquisition unit configured to acquire post-processing information for each of the plurality of images, the post-processing information being information corresponding to the images and being information about post-processing to be executed after execution of printing; and
an arrangement processing unit configured to execute arrangement processing, which is processing of setting an arrangement of the plurality of images on a medium, based on the post-processing information, wherein
when a number of adjacent images having different post-processing information, of the plurality of images, is defined as a number of adjacent different types,
the arrangement processing unit executes the arrangement processing such that the number of adjacent different types is minimized.

14. A control method for an information processing device, the control method comprising:
causing an image acceptance unit to accept a plurality of images to be print targets;
causing a post-processing information acquisition unit to acquire post-processing information for each of the plurality of images, the post-processing information being information corresponding to the images and being information about post-processing to be executed after execution of printing; and
causing an arrangement processing unit to execute arrangement processing, which is processing of setting an arrangement of the plurality of images on a medium, based on the post-processing information, wherein
when a number of adjacent images having different post-processing information, of the plurality of images, is defined as a number of adjacent different types,
the arrangement processing unit executes the arrangement processing such that the number of adjacent different types after the arrangement processing is smaller than the number of adjacent different types before the arrangement processing.

15. A non-transitory computer-readable storage medium storing a program, the program causing a computer to function as:
an image acceptance function of accepting a plurality of images to be print targets;
a post-processing information acquisition function of acquiring post-processing information for each of the plurality of images, the post-processing information being information corresponding to the images and being information about post-processing to be executed after execution of printing; and
an arrangement processing function of executing arrangement processing, which is processing of setting an arrangement of the plurality of images on a medium, based on the post-processing information, wherein
when a number of adjacent images having different post-processing information, of the plurality of images, is defined as a number of adjacent different types,
the arrangement processing function includes a function of executing the arrangement processing such that the number of adjacent different types after the arrangement processing is smaller than the number of adjacent different types before the arrangement processing.
